(19) United States
(12) Patent Application Publication
(10) Pub. No.: US 2009/0288285 A1
(43) Pub. Date: Nov. 26, 2009

(54) METHOD OF MAKING A GOLF CLUB HEAD

(75) Inventors: Hsiao-Wen CHAO, Ping-Tung Hsien (TW); Yu-Zheng HUANG, Ping-Tung Hsien (TW); Tien-Lung TANG, Ping-Tung Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: O-Ta Precision Industry Co. LTD., Ping-Tung Hsien (TW)

(21) Appl. No.: 12/239,389

(22) Filed: Sep. 26, 2008

(30) Foreign Application Priority Data
May 26, 2008 (TW) 097119351

(51) Int. Cl. B23P 11/00

(52) U.S. Cl. 29/509; 29/526.6

(57) ABSTRACT

A method of making a golf club head includes the steps of: preparing a head body including a front engaging face, a back face, an opening extending through the front engaging face and the back face, a groove extending around the opening and recessed inwardly from the front engaging face, a peripheral edge surrounding the groove, and at least one flange extending along the peripheral edge and protruding away from the front engaging face; mounting a striking plate on the front engaging face to cover the opening; bending the flange toward the striking plate and pressing the flange against the striking plate; joining the striking plate to the head body using a solder; and polishing the head body and the striking plate to remove excess of the flange and the solder.

### BACKGROUND OF THE INVENTION

1. Field of the Invention

The invention relates to a method of making a golf club head, more particularly to a method of making a golf club head having an improvement in joining a striking plate to a head body.

2. Description of the Related Art

Referring to FIG. 1, a conventional method of making a golf club head includes the steps of:

preparing a head body 11 including a front engaging face 111 forming with two grooves 113, and a rear portion 112 opposite to the front engaging face 111;

preparing a fixing device 13 including a base plate 131, and a cover 132 releasably engaged to the base plate 131 using fixing elements 134 and having a receiving space 133 with a contour corresponding to the head body 11;

applying a solder into the grooves 113 of the head body 11;

mounting a striking plate 12 on the front engaging face 111 of the head body 11 using the fixing device 13, and fixing the striking plate 12 and the head body 11 tightly between the base plate 131 and the cover 132 of the fixing device 13; and

joining the striking plate 12 to the head body 11 via hard-soldering.

Since the profile of a head body varies according to the specific requirement for a golf club head to be made, it is required to design a specific fixing device for joining a striking plate to a head body having a specific profile. Therefore, the conventional method of making a golf club head is relatively complicated, inefficient, and costly.

### SUMMARY OF THE INVENTION

Therefore, an object of the present invention is to provide a method of making a golf club head, which is improved in a manner of joining a striking plate to a head body.

Accordingly, the method of making a golf club head of this invention includes the steps of:

preparing a head body including a front engaging face, a back face, an opening extending through the front engaging face and the back face, a groove extending around the opening and recessed inwardly from the front engaging face, a peripheral edge surrounding the groove, and at least one flange extending along the peripheral edge and protruding away from the front engaging face;

mounting a striking plate on the front engaging face to cover the opening;

bending the flange toward the striking plate and pressing the flange against the striking plate; joining the striking plate to the head body using a solder; and

polishing the head body and the striking plate to remove excess of the flange and the solder.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view illustrating a conventional method of making a golf club head;

FIG. 2 is a flow chart of a preferred embodiment of a method of making a golf club head according to this invention; and

FIGS. 3 to 7 are views illustrating consecutive steps of the preferred embodiment.

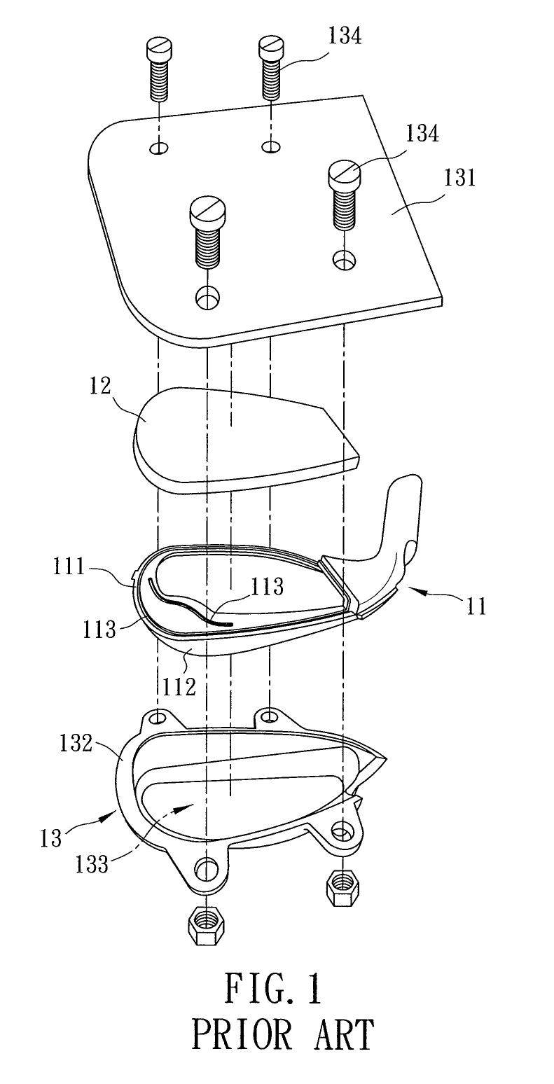

### DETAILED DESCRIPTION OF THE PREFERRED EMBODIMENT

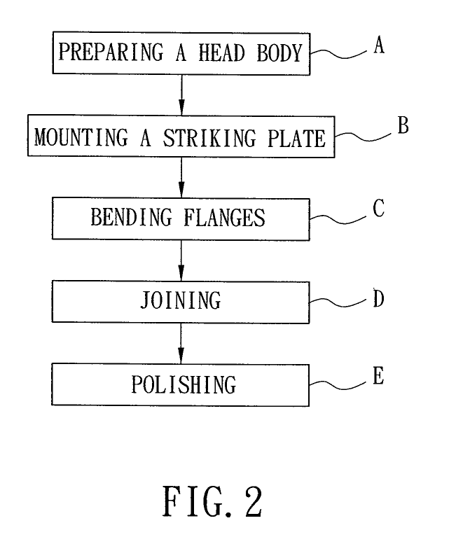

Referring to FIG. 2, the preferred embodiment of a method of making a golf club head according to this invention is shown to include the steps of:

A) Preparing a Head Body:

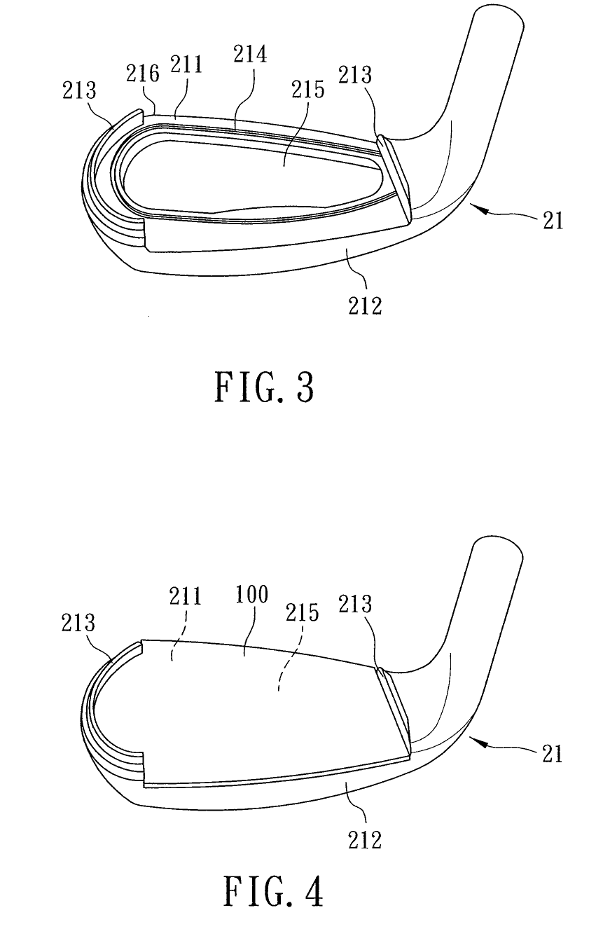

Referring to FIG. 3, a head body 21 is prepared, which includes a front engaging face 211, a back face 212 opposite to the front engaging face 211, an opening 215 extending through the front engaging face 211 and the back face 212, a groove 214 extending around the opening 215 and recessed stepwise and inwardly from the front engaging face 211, a peripheral edge 216 surrounding the groove 214, and a pair of flanges 213 extending along the peripheral edge 216 and protruding at two opposite sides of the groove 214 and away from the front engaging face 211.

B) Mounting a Striking Plate:

Referring to FIG. 4, a striking plate 100 having a predetermined shape is mounted on the front engaging face 211 to cover the opening 215 so that the striking plate 100 is positioned between the pair of flanges 213.

C) Bending the Flanges:

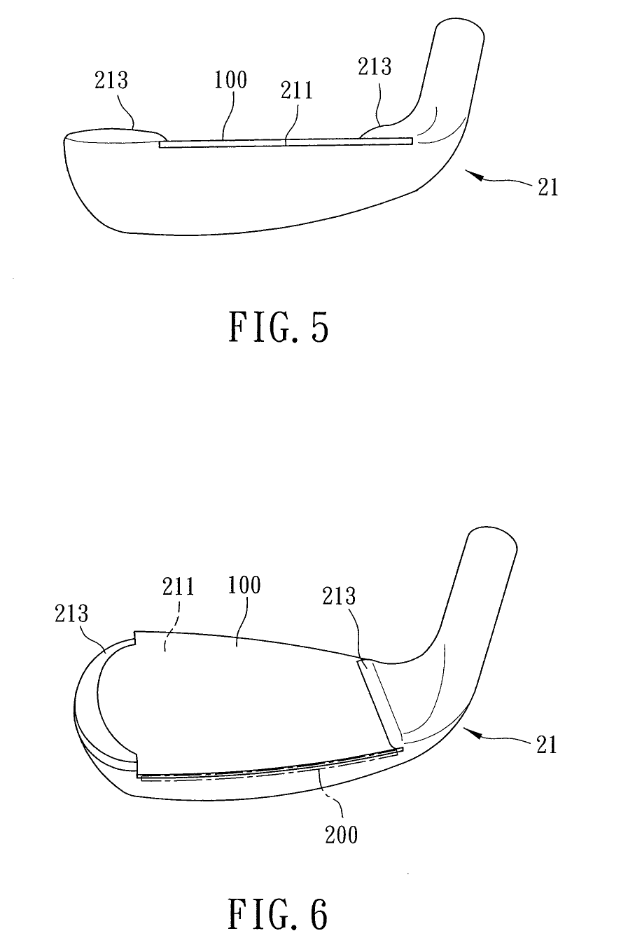

Referring to FIG. 5, the flanges 213 are bent toward the striking plate 100 and are pressed against the striking plate 100 via roller-pressing so that the striking plate 100 is fixed on the front engaging face 211 of the head body 21 by the flanges 213.

D) Joining:

Referring to FIG. 6, the striking plate 100 is joined to the head body 21 using a solder 200. The joining step is conducted by applying the solder 200 into a gap between the front engaging face 211 and the striking plate 100, and causing the solder 200 to melt, penetrate into the gap, and flow into the groove 214 by heating, thereby joining the striking plate 100 to the head body 21 after cooling. It should be noted that since the groove 214 is stepwise, it is relatively easy to guide the molten solder 200 from the gap between the front engaging face 211 and the striking plate 100 into the groove 214 so as to further facilitate the joining of the striking plate 100 to the head body 21.

E) Polishing:

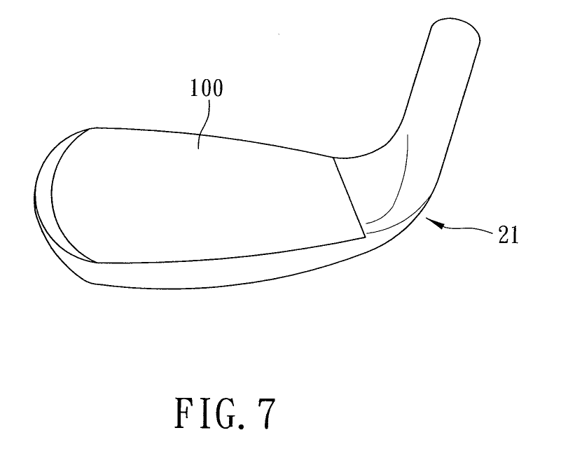

Referring to FIG. 7, the head body 21 and the striking plate 100 are polished to remove excess of the flanges 213 and the solder 200 and to impart a smooth surface to the golf club head.

In view of the aforesaid, it is not necessary to use a fixing device in the method of making a golf club head of this invention. Therefore, the present invention is relatively flexible, and the production cost can be reduced by the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method of making a golf club head, comprising the steps of:
preparing a head body including a front engaging face, a back face, an opening extending through the front engaging face and the back face, a groove extending around the opening and recessed inwardly from the front engaging face, a peripheral edge surrounding the groove, and at least one flange extending along the peripheral edge and protruding away from the front engaging face;
mounting a striking plate on the front engaging face to cover the opening;
bending the flange toward the striking plate and pressing the flange against the striking plate;
joining the striking plate to the head body using a solder; and
polishing the head body and the striking plate to remove excess of the flange and the solder.

2. The method as claimed in claim 1, wherein the head body is formed with a pair of the flanges protruding at two opposite sides of the groove.

3. The method as claimed in claim 1, wherein the flange is bent and pressed by roll-pressing.
